(19) United States
(12) Patent Application Publication
(10) Pub. No.: US 2006/0221218 A1
(43) Pub. Date: Oct. 5, 2006

(54) Image sensor with improved color filter

(76) Inventors: Doron Adler, Nesher (IL); David Hanuka, Ramat Yishay (IL)

Correspondence Address: GANZ LAW, P.C., P O BOX 2200, HILLSBORO, OR, 97123, US

(21) Appl. No.: 11/100,076

(22) Filed: Apr. 5, 2005

(51) Int. Cl. H04N 9/083

(52) U.S. Cl. 348/266

(57) ABSTRACT

An image sensor assembly includes a solid-state image sensor, the sensor including a matrix of detector elements including respective first and second pluralities of the detector elements producing respective first and second signals and having different, respective first and second sensitivities. The sensor assembly includes a signal extraction circuit, including first and second amplifiers for amplifying the first and second signals, respectively, with different, respective first and second amplification gains responsive to the first and second sensitivities.

### FIELD OF THE INVENTION

The present invention relates generally to electronic imaging systems, and particularly to color image sensors used in medical imaging systems.

### BACKGROUND OF THE INVENTION

Miniature, remote-head cameras are commonly used in endoscopy and other areas of minimally-invasive surgery. A solid-state image sensor is fixed in the distal end of an endoscope, along with suitable imaging optics and an illumination source, in order to capture images within body cavities and passageways.

A wide variety of distal-end camera heads have been described in the patent literature, based mainly on integration of the sensor, typically a CCD-based or CMOS sensor, with suitable miniature optics. Some exemplary camera head designs are described in U.S. Pat. Nos. 4,604,992, 4,491,865, 4,746,203, 4,720,178, 5,166,787, 4,803,562, and 5,594,497.

Endoscopic imaging applications typically employ color camera heads, providing physicians with more information and enabling better observation of body tissue. Color cameras can be divided into three-chip and single-chip cameras, referring to the solid-state sensors which capture the image. A three-chip camera uses three separate image sensors, each sensor viewing the same object through a different color optical filter. The three filters typically cover the primary colors red, green and blue (RGB), providing each sensor with a filtered image containing the optical spectrum corresponding to one primary color.

A single-chip camera uses a single solid-state image sensor. Color selectivity is achieved by applying a multi-colored color filter to the image sensor, providing different color filtering to different detector elements of the image sensor. A typical configuration is to apply a filter structure called a “mosaic filter” to the surface of the image sensor. A mosaic filter is a mask of miniature color filter elements in which a filter element is positioned in front of each detector element of the image sensor. The filter elements typically alternate between the primary RGB colors, or between the complementary colors cyan, magenta, green and yellow. In either case, full color information (chrominance) may be reconstructed using these colors. The monochrome intensity (luminance) signal can also be extracted, as will be explained below. For example, U.S. Pat. No. 4,697,208, whose disclosure is incorporated herein by reference, describes a color image pickup device that has a solid-state image sensing element and a complementary color type mosaic filter.

One technique used in digital video applications for constructing a color mosaic filter is called a “Bayer sensor” or “Bayer mosaic.” A typical Bayer mosaic has the following configuration (Each square in the mask represents a color filter element corresponding to a single detector element of the image sensor. The letters represent colors—R denotes red, G denotes green and B denotes blue):

| | | | | | |
|---|---|---|---|---|---|
| R | G | R | G | R | G |
| G | B | G | B | G | B |
| R | G | R | G | R | G |
| G | B | G | B | G | B |
| R | G | R | G | R | G |
| G | B | G | B | G | B |

The Bayer mosaic is also described in U.S. Pat. No. 3,971,065, whose disclosure is incorporated herein by reference. Processing the image produced by the Bayer mosaic typically involves reconstructing the full color image by extracting three color signals (red, green and blue). An alternative processing method involves representing the image in terms of two signals: Luminance (“Y signal”), which represents the total light intensity, integrating the entire color spectrum, and Chrominance (“C signal”), which contains the color information. The magnitude of the C signal corresponds to color saturation: low magnitudes correspond to a gray image, high magnitudes to saturated color. The phase of the C signal corresponds to wavelength.

One simple example known in the art for processing the output of a Bayer mosaic, generating both Y/C and RGB signals, is given by the following method:
Consider the magnitude of the signal provided by the green pixels (G) to represent the luminance (Y) signal, since the green color lies in the middle of the spectrum.
Obtain the color components for the remaining, non-G color pixels by interpolation between the R and B signals of the G neighbors. (R and B denote the signal magnitude of the signal provided by the red and blue pixels.)
Calculate the red and blue chrominance signals (Cr, Cb) of the red and blue pixels as:
   Cr=R−Y
   Cb=B−Y
Fill in missing Cr and Cb values (spatially) by interpolation of nearest available Cr and Cb values.
Y, Cr and Cb as such are sufficient to generate a composite signal. RGB reconstruction can be achieved by:
   R=Y+Cr
   B=Y+Cb
   G=(Y−0.3R−0.1B)/0.6

Dynamic range is an important design factor for image sensors. On one hand, the sensor should be sensitive, i.e., provide a high quality picture in low lighting conditions. On the other hand, the same sensor should operate without saturating when light intensity is high. U.S. Pat. No. 5,323,233, whose disclosure is incorporated herein by reference, addresses the dynamic range issue by providing an image sensor with color filters for passing luminance and color light components. A signal processing unit receives signals corresponding to the luminance and color components, and generates a color difference signal.

An electronic shutter may be used to limit the exposure time of the image sensor detector elements in response to changing light conditions. Setting a short exposure time prevents a detector element from saturating when the light intensity is high. A long exposure time allows the detector element to accumulate light energy over a longer time interval, thereby increasing its sensitivity when light intensity is low.

Another important design factor in image sensors is crosstalk. Crosstalk is the amount of unwanted coupling between adjacent detector elements. Optical crosstalk is the amount of light energy, resulting from the structure of the image sensor and the imaging optics, “spilling over” to adjacent detector elements. Electronic crosstalk is the amount of unwanted coupling of signals to adjacent detector elements, introduced by the electronic circuitry that extracts information from the detector elements.

### SUMMARY OF THE INVENTION

Embodiments of the present invention provide single-chip color image sensor configurations that provide improved imaging performance over conventional mosaic-based image sensor designs, such as the Bayer sensor design.

In some embodiments, an image sensor comprises a mosaic filter that provides enhanced sensitivity by introducing clear elements into the mosaic, so that the corresponding detector elements receive white light.

In other embodiments, the mosaic filter is designed to provide enhanced color information in the red region of the optical spectrum, a region that is of particular importance to intracorporeal imaging applications, such as endoscopy.

In some embodiments of the present invention, novel circuitry associated with a mosaic-based image sensor provides improved dynamic range and reduced crosstalk. In some of these embodiments, different gain amplification is applied to detector elements corresponding to different colors in the mosaic in order to compensate for variations in the attenuation of the different color filter elements and in the sensitivity of the detector elements to the different colors. In other embodiments, a selective electronic shutter mechanism is used to extend the dynamic range of the image sensor.

There is therefore provided, in accordance with an embodiment of the present invention, an image sensor assembly, including:

a solid-state image sensor, the sensor including a matrix of detector elements including respective first and second pluralities of the detector elements producing respective first and second signals and having different, respective first and second sensitivities; and

a signal extraction circuit, including first and second amplifiers for amplifying the first and second signals, respectively, with different, respective first and second amplification gains responsive to the first and second sensitivities.

In a disclosed embodiment, the image sensor assembly includes a mosaic filter, which includes filter elements associated respectively with the detector elements, the filter elements having at least first and second different responses, wherein the first and second sensitivities are determined by the responses of the filter elements.

Additionally or alternatively, the filter elements include a first plurality of clear elements associated with the first plurality of the detector elements and a second plurality of colored elements associated with the second plurality of the detector elements, wherein the second amplification gain is greater than the first amplification gain.

Further additionally or alternatively, the mosaic filter includes a pattern of clear, red and blue filter elements. In a disclosed embodiment, the pattern further includes green filter elements. In yet another embodiment, more than one half of the filter elements are clear.

In still another embodiment, the detector elements are arranged in columns on a semiconductor substrate, and the first and second amplifiers include first and second pluralities of amplifiers, which are formed on the semiconductor substrate such that each of the amplifiers is associated with a respective column of the detector elements.

In another disclosed embodiment, the signal extraction circuit includes a switch, which is coupled to direct the first and second signals in alternation to the first and second amplifiers.

In a disclosed embodiment, the sensor assembly includes an electronic shutter circuit coupled to the image sensor, the electronic shutter setting a first exposure time for the first plurality of the detector elements and a second exposure time, greater than the first exposure time, for the second plurality of the detector elements.

There is additionally provided, in accordance with an embodiment of the present invention, an image sensor assembly, including:

a solid-state image sensor, the sensor including a matrix of detector elements; and

a mosaic filter including filter elements associated respectively with the detector elements, the filter elements including at least a first plurality of red elements, a second plurality of green elements and a third plurality of elements having a spectral response between red and green regions of the optical spectrum.

In a disclosed embodiment, the filter elements include a fourth plurality of blue elements.

In another embodiment, the sensor assembly includes a mosaic filter associated with the solid-state image sensor, the mosaic filter including filter elements having at least first and second different responses, wherein the first and second sensitivities are determined by the responses of the filter elements.

In yet another embodiment, the sensor assembly includes a semiconductor substrate, on which the matrix of detector elements and the signal extraction circuit are both formed.

There is also provided, in accordance with an embodiment of the present invention, an image sensor assembly including:

a solid-state image sensor, the sensor including a matrix of detector elements including respective first and second pluralities of the detector elements producing respective first and second signals and having different, respective first and second sensitivities; and

an electronic shutter circuit, which is coupled to set first and second exposure times, respectively, for the first and second pluralities of detector elements, responsively to the first and second sensitivities.

In a disclosed embodiment, the image sensor includes a mosaic filter associated with the solid-state image sensor, the mosaic filter including filter elements having at least first and second different responses, wherein the first and second sensitivities are determined by the responses of the filter elements.

In another disclosed embodiment, the image sensor includes a semiconductor substrate, on which the matrix of detector elements and the electronic shutter circuit are both formed.

There is further provided, in accordance with an embodiment of the present invention, an endoscope including:

an insertion tube having a distal end; and

a camera head assembly disposed in the distal end of the insertion tube, the camera head assembly including:

an image sensor assembly, including:

a solid-state image sensor, the sensor including a matrix of detector elements including respective first and second pluralities of the detector elements producing respective first and second signals and having different, respective first and second sensitivities; and

a signal extraction circuit, including first and second amplifiers for amplifying the first and second signals, respectively, with different, respective first and second amplification gains responsive to the first and second sensitivities; and

an optical assembly for collecting optical radiation from an object outside the distal end of the insertion tube and focusing the optical radiation onto the image sensor assembly.

There is also provided, in accordance with an embodiment of the present invention, an endoscope including:

an insertion tube having a distal end; and

a camera head assembly disposed in the distal end of the insertion tube, the camera head assembly including:

an image sensor assembly, including:

a solid-state image sensor, the sensor including a matrix of detector elements; and

a mosaic filter including filter elements associated respectively with the detector elements, the filter elements including at least a first plurality of red elements, a second plurality of green elements and a third plurality of elements having a spectral response between the red and green regions of the optical spectrum; and

an optical assembly for collecting optical radiation from an object outside the distal end of the insertion tube and focusing the optical radiation onto the image sensor.

There is additionally provided, in accordance with an embodiment of the present invention, a camera head assembly including:

an image sensor assembly, including:

a solid-state image sensor, the sensor including a matrix of detector elements; and

a mosaic filter including filter elements associated respectively with the detector elements, the filter elements including at least a first plurality of red elements, a second plurality of green elements and a third plurality of elements having a spectral response between the red and green regions of the optical spectrum; and

an optical assembly for collecting optical radiation from an object and focusing the optical radiation onto the image sensor.

There is also provided, in accordance with an embodiment of the present invention, a method for image sensing, including:

forming a solid-state image sensor, the sensor including a matrix of detector elements including respective first and second pluralities of the detector elements producing respective first and second signals and having different, respective first and second sensitivities;

determining first and second amplification gains responsively to the respective first and second sensitivities; and

amplifying the first and second signals, respectively, using the respective first and second amplification gains.

There is additionally provided, in accordance with an embodiment of the present invention, a method for image sensing, including:

forming a solid-state image sensor, the sensor including a matrix of detector elements; and

applying a mosaic filter to the image sensor, the mosaic filter including filter elements associated respectively with the detector elements, the filter elements including at least a first plurality of red elements, a second plurality of green elements and a third plurality of elements having a spectral response between red and green regions of the optical spectrum.

There is further provided, in accordance with an embodiment of the present invention, a method for image sensing including:

forming a solid-state image sensor, the sensor including a matrix of detector elements including respective first and second pluralities of the detector elements producing respective first and second signals and having different, respective first and second sensitivities;

determining first and second exposure times, responsively to the respective first and second sensitivities; and

exposing the first and second pluralities of the detector elements for a duration of the respective first and second exposure times.

The present invention will be more fully understood from the following detailed description of the embodiments thereof, taken together with the drawings in which:

### BRIEF DESCRIPTION OF THE DRAWINGS

FIG. 1 is a block diagram that schematically illustrates an endoscopic imaging system, in accordance with an embodiment of the present invention;

FIG. 2 is a schematic, sectional diagram of a camera head assembly, in accordance with an embodiment of the present invention;

FIG. 3 is a schematic isometric view of an image sensor assembly, in accordance with an embodiment of the present invention;

FIGS. 4A-4C are schematic top views of a color mosaic filter, in accordance with embodiments of the present invention;

FIG. 5 is a schematic top view of a color mosaic filter, in accordance with another embodiment of the present invention;

FIG. 6 is a schematic plot of a color filter spectral response, in accordance with an embodiment of the present invention;

FIG. 7 is a schematic block diagram of a detector matrix and associated circuitry, in accordance with an embodiment of the present invention; and

FIG. 8 is a schematic block diagram of a camera head assembly, in accordance with an embodiment of the present invention.

### DETAILED DESCRIPTION OF EMBODIMENTS

FIG. 1 is a block diagram that schematically illustrates an endoscopic imaging system 20, in accordance with an embodiment of the present invention. System 20 comprises an endoscope 22, which is connected by a cable 24 to a processing unit 26. The endoscope comprises an insertion tube 28, containing a miniature camera head at its distal end 30, as shown and described hereinbelow. In some embodiments, the endoscope also contains an internal light source (not shown in this figure), for illuminating the area adjacent to the distal end of the endoscope, which is imaged by the camera head. Alternatively or additionally, an external light source 32 may be used to provide illumination via a fiberoptic bundle 34 to a light guide within endoscope 22. A display unit 36 displays the color images taken by the camera.

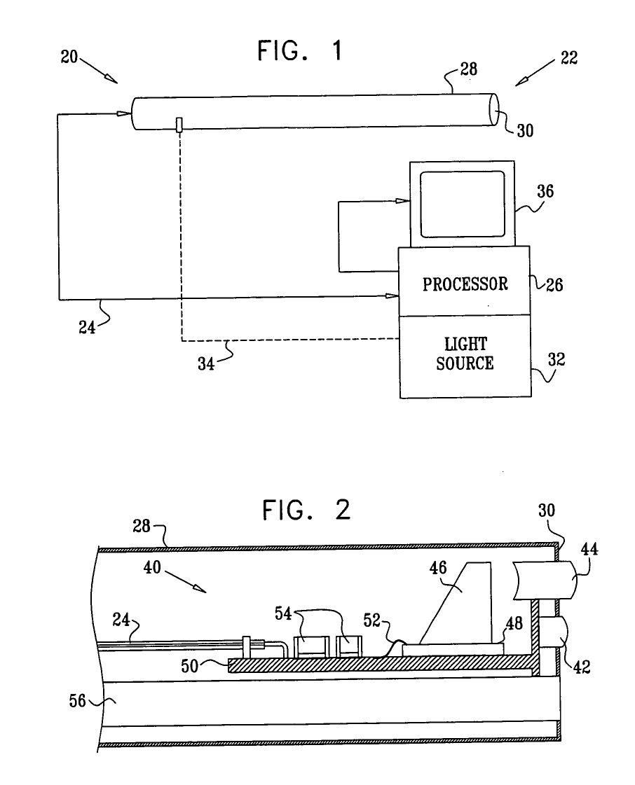

FIG. 2 is a schematic, sectional illustration showing a miniature camera head assembly 40 within insertion tube 28, in accordance with an embodiment of the present invention. In this embodiment, one or more light sources 42, typically comprising LEDs, illuminate the region immediately distal to endoscope 22. An optical objective 44, mounted at distal end 30, collects and focuses light from objects illuminated by light source 42. A turning mirror, typically comprising a right angle prism 46, reflects the light collected by objective 44 to focus on the focal plane of an image sensor assembly 48. Sensor assembly 48 typically comprises a two-dimensional matrix of detector elements, overlaid by a color mosaic filter, as will be explained in detail hereinbelow. The detector matrix may be based on CMOS, CCD or other solid-state imaging technology, as is known in the art. Sensor assembly 48 is mounted on a circuit substrate 50, typically a printed circuit board (PCB).

Cable 24 passing through endoscope 22 connects assembly 40 to processing unit 26. One or more controller and communication interface chips 54 on substrate 50 serve to pass electrical signals from image sensor assembly 48 to processing unit 26 and to receive control inputs from the processing unit. A working channel 56, which runs substantially the entire length of endoscope 22, is typically located beneath substrate 50.

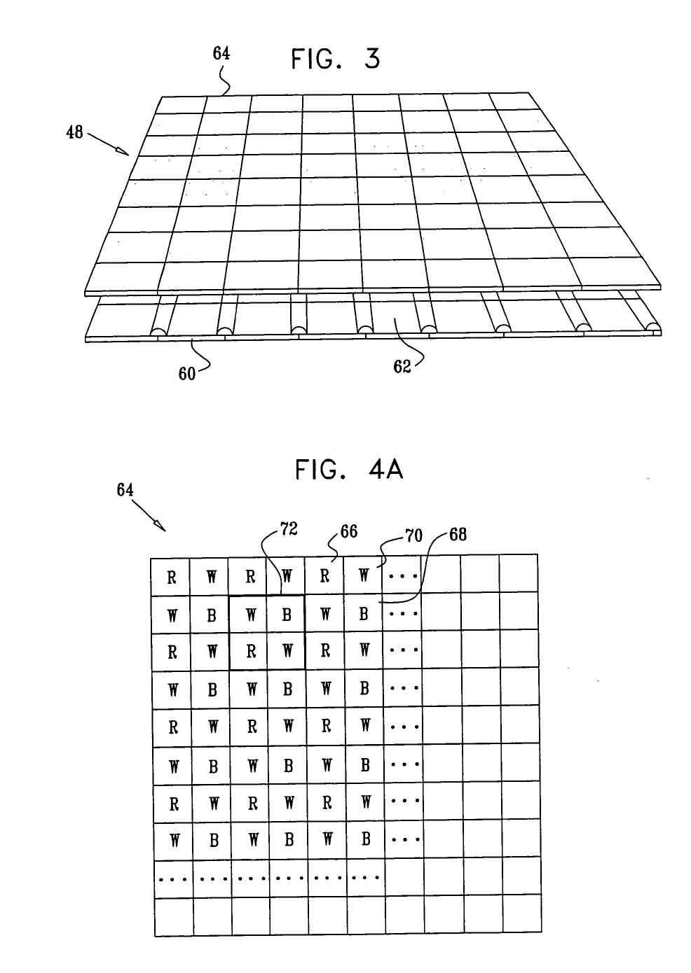

FIG. 3 is a schematic isometric view of image sensor assembly 48, in accordance with an embodiment of the present invention. The assembly comprises a matrix 60 of detector elements 62 fabricated on a semiconductor substrate. The detector elements in matrix 60 are typically sensitive to the entire visible and near infrared color spectrum. A color mosaic filter 64 is overlaid on the surface of the detector matrix. Each element of the mosaic filter may comprise a color filter, transmitting a partial sub-band of the spectrum of the incoming light. Alternatively, some of the filter elements may be clear, as shown in the embodiment that follows.

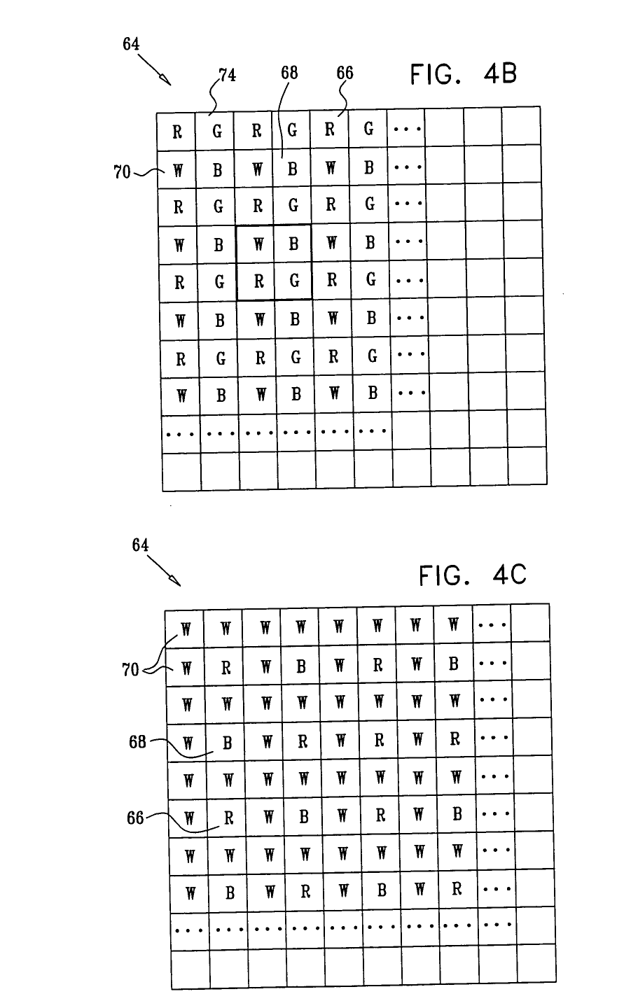

FIG. 4A is a schematic top view of color mosaic filter 64, in accordance with an embodiment of the present invention. Mosaic filter 64 comprises red filter elements 66, blue filter elements 68 and clear elements 70 (labeled W, to identify them as “white” elements). The clear elements are typically transparent and transmit the entire visible spectrum. Elements 70 may be designed to block infrared radiation. Alternatively, for enhanced sensitivity, some or all of elements 70 may be designed to pass the infrared radiation in addition to visible light. The filter elements and the clear elements are distributed across the matrix in an alternating pattern. In each square of 2-by-2 elements, such as a square 72 shown in FIG. 4A, there are two clear elements, one blue filter element and one red filter element. This configuration allows reconstruction of the RGB signals by interpolating neighboring color values.

The disclosed mosaic filter configuration provides better light sensitivity than the traditional Bayer mosaic, because of the clear elements. A color filter, by the very nature of the filtering operation, lets through only a part of the spectrum, thereby reducing the total amount of light reaching the detector. Each color element of a typical color mosaic filter allows only 25-35% of the light to reach the corresponding detector element. In some applications, which require operation in low lighting conditions, the resulting loss of 65-75% of the incident light intensity is unacceptable. In addition, poor sensitivity of the detector elements typically requires light source 42 to be stronger. There is therefore a particular motivation to improve the sensitivity of the image sensor assembly.

In the configuration shown in FIG. 4A, half of the filter elements are clear, providing a more sensitive sensor assembly. The luminance signal typically carries most of the picture high-frequency information. Therefore the disclosed configuration also enables better resolution. Given the white, blue and red signals, the green signal may be reconstructed by subtracting the red and blue values from the white value provided by the clear elements, using the relation G=(W−0.3R−0.1B)/0.6 given above.

FIGS. 4B and 4C are schematic top views showing alternative implementations of color mosaic filter 64, in accordance with embodiments of the present invention.

FIG. 4B shows a pattern comprising the clear (70) elements, the red (66) and blue (68) filter elements, and additional green filter elements 74. This configuration offers good color resolution without the need to reconstruct the green color signal. A sensitive luminance signal is provided by the clear elements.

FIG. 4C shows another alternative pattern comprising red, blue and clear elements. In the configuration of FIG. 4C, ¾ of the elements of mosaic 64 comprise clear elements 70, ⅛ of the elements comprise red filter elements 66 and ⅛ comprise blue filter elements 68. This configuration offers better sensitivity and high-frequency resolution due to the large number of clear elements, at the expense of some degradation in color resolution.

Other alternative arrangements of filter elements including clear elements may be used, as will be apparent to those skilled in the art. For example, clear elements may be incorporated in a CMYG (cyan-magenta-yellow-green) mosaic pattern.

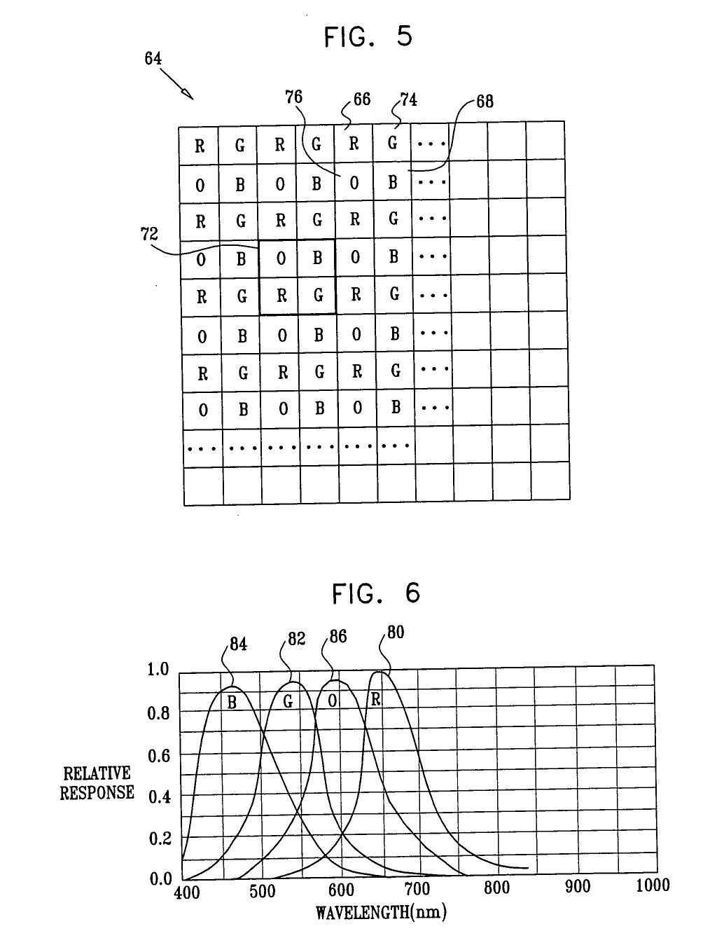

FIG. 5 shows an alternative configuration of color mosaic filter 64, in accordance with another embodiment of the present invention. It is well known in the art that the red region of the optical spectrum is of particular importance to intracorporeal imaging applications, containing a significant amount of picture information. There is therefore motivation for emphasizing this region of the spectrum when designing such imaging systems. The disclosed embodiment provides processing unit 26 with additional picture information in a particular region-of-interest of the optical spectrum.

Mosaic filter 64 shown in FIG. 5 comprises the red (66) and blue (68) filter elements also shown in the previous embodiment, as well as green filter elements 74 completing the palette of RGB primary colors. Additional orange color filter elements 76 are added to provide additional color resolution in the red spectral region. Typical spectral responses of the color filter elements are shown in FIG. 6 below. The red, green, blue and orange filter elements are distributed across the mosaic in an alternating pattern, as shown in FIG. 5. Each square 72 of 2×2 pixels comprises one filter element of each color. Alternatively, other colors (such as yellow) and other arrangements of the filter elements may be used.

Reference is now made to FIG. 6, which is a schematic plot of the spectral response of the filter elements of mosaic filter 64, in accordance with an embodiment of the present invention. The horizontal axis of FIG. 6 represents wavelength in nanometers. The vertical axis represents the relative filter response, on a linear scale of 0 to 1. Plot 80 represents a typical response for the red filter elements 66. Plot 82 represents a typical response for the green filter elements 74. Plot 84 represents a typical response for the blue filter elements 68. Finally, plot 86 represents a typical response for the orange filter elements 76. It can be seen that the spectrum covered by plot 86 provides additional enhancement of the red region of the optical spectrum, improving the color resolution in this region.

It should be noted that different colors and different spectral responses may be chosen as the fourth filter type, for enhancing different parts of the optical spectrum as required by a particular application.

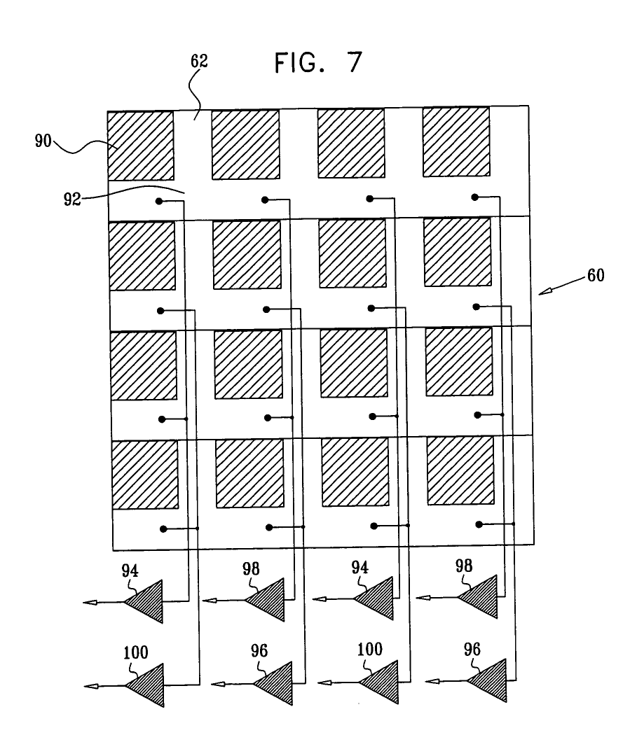

FIG. 7 is a schematic block diagram of matrix 60 and associated circuitry, in accordance with an embodiment of the present invention. The disclosed embodiment improves the dynamic range of the image sensor assembly 48 by providing amplifiers of different gains to detector elements corresponding to different color filter elements in the mosaic. Each detector element 62 of image sensor 60 typically comprises an active area 90, which is sensitive to incoming light, and a signal extraction circuit 92, which produces an electric signal corresponding to the amount of charge accumulated by the active area of the detector element in response to the incoming light. The extracted signals are multiplexed, typically line-by-line, amplified by amplifiers 94, 96, 98 and 100, and provided as output signals of sensor assembly 48. Typically, amplifiers 94, 96, 98 and 100 are fabricated on the same semiconductor chip as detector elements 62. The output signals are subsequently transferred to processing unit 26 for processing and displaying of color images. Typically, two amplifiers are provided for each column of the detector matrix, to support the alternating color patterns of the color mosaic.

In one embodiment, the gains of amplifiers 94, 96, 98 and 100 are predefined according to the color filter elements of the mosaic filter. For example, detector elements that are associated with clear elements in the mosaic filter typically receive much higher average light intensity (and thus have a higher sensitivity) than the detector elements associated with red and blue filter elements. Therefore the corresponding amplifier of the clear light detector elements is set to a lower gain than that of the colored light detector elements. The nominal amplifier gains are typically selected so as to provide an approximately uniform output signal level for all detector elements. This uniform output level increases the dynamic range of the image by reducing the differences between the average signal levels corresponding to the different detector elements.

For example, assume that image sensor 60 of FIG. 7 is overlaid by the red, blue and clear mosaic shown in FIG. 4. In this case, amplifier 94 handles signals from detector element associated with red filter elements and amplifier 96 handles detector elements associated with blue filter elements. Amplifiers 98 and 100 both handle clear elements. Therefore, the gain of amplifiers 94 and 96 will typically be set to 2-4 times higher than the gain of amplifiers 98 and 100. Alternatively, the amplifier gains may be set adaptively, depending on the lighting conditions and color spectrum of the image.

The circuitry shown in FIG. 7 may alternatively be used with an image sensor having a conventional Bayer RGB mosaic filter. In devices known in the art, the same output amplification is applied to the output of all the detector elements. In an embodiment of the present invention, different gains are applied to the R, G and B detector elements in order to compensate for differences in sensitivity of the corresponding detector elements to incident light and/or for lighting conditions and the color spectrum of the image.

In another embodiment, signal extraction circuit 92 comprises an electronic shutter mechanism. The electronic shutter sets a different exposure time for different detector elements, according to the corresponding color filter elements in the mosaic filter. Typically, the exposure time of detector elements associated with clear filter elements will be asset to be 3-4 times shorter than that of the detector elements associated with colored filter elements.

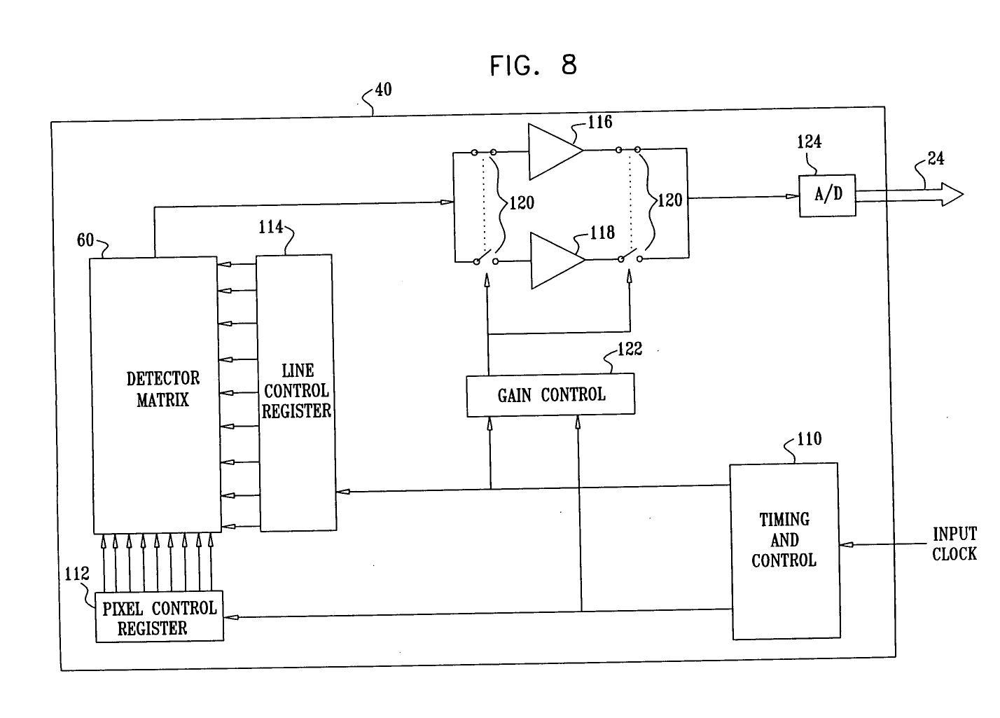

FIG. 8 is a schematic block diagram of camera head assembly 40, in accordance with an embodiment of the present invention. Similarly to the configuration shown in FIG. 7 above, this embodiment provides amplifiers of different gains to detector elements corresponding to different color filter elements in the mosaic. The configuration of FIG. 8 offers the benefit of using only a single set of amplifiers for amplifying signals from the entire detector matrix.

A timing and control circuit 110 controls the timing of extracting signals from the detector elements of matrix 60. Circuit 110 controls a pixel control register 112 and a line control register 114, for extracting the signals from the detector matrix sequentially in a line-by-line pattern. The extracted signals are amplified by one of two gain paths 116 and 118. Gain paths 116 and 118 comprise amplifiers having different gains. Typically, signals that correspond to the colored filter elements of matrix 60 are amplified by the higher-gain path. Signals that correspond to the clear elements of matrix 60 are typically amplified by the lower-gain path.

The timing and control circuit sends timing signals to a gain control circuit 122, for synchronizing the latter with the signal extraction process. Gain control circuit 122, based on the pattern of colored and clear elements of matrix 60, controls switches 120 for switching each extracted signal to the appropriate gain path, typically according to the sensitivity of the respective detector element. Finally, the extracted signals are converted to digital format using an analog-to-digital (A/D) converter 124. The digital signals are then sent over cable 24 to processing unit 26.

In one embodiment, unit 26 multiplies the signal from each detector type by a different coefficient in order to compensate for the different sensitivities of the different detector types. In another embodiment, color reconstruction is implemented using a linear transformation. Unit 26 constructs vectors comprising the color signal values associated with a given image pixel, as transferred from the camera head or after interpolation. Unit 26 multiplies each vector by a predetermined correction matrix to produce three color pixels (typically red, green and blue), subsequently displayed by display unit 36. If the mosaic filter comprises three different colors, the matrix is a 3×3 matrix. If the mosaic comprises four colors, such as the matrix shown in FIG. 5, the matrix is a 3×4 matrix, producing a 3-tuple of red, green and blue pixels per each 4-tuple of red, green, orange and blue input values. As noted in the description of FIG. 5 above, this transformation enhances the color information in the red region of the spectrum, which has particular importance in medical imaging applications. Other embodiments may use non-linear transformations instead of the matrix operation described above.

Although the configuration shown in FIG. 8 comprises two gain paths, a different number of gain paths may be used, to suit different detector sensitivities in matrix 60. Additionally or alternatively, the configuration of FIG. 8 may be operated in conjunction with an electronic shutter mechanism, as explained above.

Although the embodiments described above relate specifically to endoscopic imaging systems, the principles of the present invention may similarly be applied in electronic imaging cameras and systems that use color mosaic-based image sensors. It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. An image sensor assembly, comprising:
a solid-state image sensor, the sensor comprising a matrix of detector elements comprising respective first and second pluralities of the detector elements producing respective first and second signals and having different, respective first and second sensitivities; and
a signal extraction circuit, comprising first and second amplifiers for amplifying the first and second signals, respectively, with different, respective first and second amplification gains responsive to the first and second sensitivities.

2. The image sensor assembly according to claim 1, and comprising a mosaic filter, which comprises filter elements associated respectively with the detector elements, the filter elements having at least first and second different responses, wherein the first and second sensitivities are determined by the responses of the filter elements.

3. The image sensor according to claim 2, wherein the filter elements comprise a first plurality of clear elements associated with the first plurality of the detector elements and a second plurality of colored elements associated with the second plurality of the detector elements, wherein the second amplification gain is greater than the first amplification gain.

4. The image sensor assembly according to claim 3, wherein the mosaic filter comprises a pattern of clear, red and blue filter elements.

5. The image sensor assembly according to claim 4, wherein the pattern further comprises green filter elements.

6. The image sensor assembly according to claim 4, wherein more than one half of the filter elements are clear.

7. The image sensor assembly according to claim 1, wherein the detector elements are arranged in columns on a semiconductor substrate, and wherein the first and second amplifiers comprise first and second pluralities of amplifiers, which are formed on the semiconductor substrate such that each of the amplifiers is associated with a respective column of the detector elements.

8. The image sensor assembly according to claim 1, wherein the signal extraction circuit comprises a switch, which is coupled to direct the first and second signals in alternation to the first and second amplifiers.

9. The image sensor according to claim 2, and comprising an electronic shutter circuit coupled to the image sensor, the electronic shutter setting a first exposure time for the first plurality of the detector elements and a second exposure time, greater than the first exposure time, for the second plurality of the detector elements.

10. An image sensor assembly, comprising:
a solid-state image sensor, the sensor comprising a matrix of detector elements; and
a mosaic filter comprising filter elements associated respectively with the detector elements, the filter elements comprising at least a first plurality of red elements, a second plurality of green elements and a third plurality of elements having a spectral response between red and green regions of the optical spectrum.

11. The image sensor assembly according to claim 10, wherein the filter elements comprise a fourth plurality of blue elements.

12. The image sensor assembly according to claim 1, and comprising a mosaic filter associated with the solid-state image sensor, the mosaic filter comprising filter elements having at least first and second different responses, wherein the first and second sensitivities are determined by the responses of the filter elements.

13. The image sensor assembly according to claim 1, and comprising a semiconductor substrate, on which the matrix of detector elements and the signal extraction circuit are both formed.

14. An image sensor assembly comprising:
a solid-state image sensor, the sensor comprising a matrix of detector elements comprising respective first and second pluralities of the detector elements producing respective first and second signals and having different, respective first and second sensitivities; and
an electronic shutter circuit, which is coupled to set first and second exposure times, respectively, for the first and second pluralities of detector elements, responsively to the first and second sensitivities.

15. The image sensor assembly according to claim 14, and comprising a mosaic filter associated with the solid-state image sensor, the mosaic filter comprising filter elements having at least first and second different responses, wherein the first and second sensitivities are determined by the responses of the filter elements.

16. The image sensor assembly according to claim 14, and comprising a semiconductor substrate, on which the matrix of detector elements and the electronic shutter circuit are both formed.

17. An endoscope comprising:
an insertion tube having a distal end; and
a camera head assembly disposed in the distal end of the insertion tube, the camera head assembly comprising:
an image sensor assembly, comprising:
a solid-state image sensor, the sensor comprising a matrix of detector elements comprising respective first and second pluralities of the detector elements producing respective first and second signals and having different, respective first and second sensitivities; and
a signal extraction circuit, comprising first and second amplifiers for amplifying the first and second signals, respectively, with different, respective first and second amplification gains responsive to the first and second sensitivities; and
an optical assembly for collecting optical radiation from an object outside the distal end of the insertion tube and focusing the optical radiation onto the image sensor assembly.

18. An endoscope comprising:
an insertion tube having a distal end; and
a camera head assembly disposed in the distal end of the insertion tube, the camera head assembly comprising:
an image sensor assembly, comprising:
a solid-state image sensor, the sensor comprising a matrix of detector elements; and
a mosaic filter comprising filter elements associated respectively with the detector elements, the filter elements comprising at least a first plurality of red elements, a second plurality of green elements and a third plurality of elements having a spectral response between the red and green regions of the optical spectrum; and
an optical assembly for collecting optical radiation from an object outside the distal end of the insertion tube and focusing the optical radiation onto the image sensor.

19. A camera head assembly comprising:
an image sensor assembly, comprising:
a solid-state image sensor, the sensor comprising a matrix of detector elements; and
a mosaic filter comprising filter elements associated respectively with the detector elements, the filter elements comprising at least a first plurality of red elements, a second plurality of green elements and a third plurality of elements having a spectral response between the red and green regions of the optical spectrum; and
an optical assembly for collecting optical radiation from an object and focusing the optical radiation onto the image sensor.

20. A method for image sensing, comprising:
forming a solid-state image sensor, the sensor comprising a matrix of detector elements comprising respective first and second pluralities of the detector elements producing respective first and second signals and having different, respective first and second sensitivities;
determining first and second amplification gains responsively to the respective first and second sensitivities; and
amplifying the first and second signals, respectively, using the respective first and second amplification gains.

21. The method according to claim 20, wherein forming the solid-state image sensor comprises applying a mosaic filter to the image sensor, the mosaic filter comprising filter elements associated respectively with the detector elements, the filter elements comprising a first plurality of clear elements associated with the first plurality of the detector elements and a second plurality of colored elements associated with the second plurality of the detector elements, and wherein amplifying the first and second signals comprises applying the first amplification gain to the first signal and applying the second amplification gain, which is greater than the first amplification gain, to the second signal.

22. The method according to claim 21, wherein applying the mosaic filter comprises applying a pattern of clear, red and blue filter elements.

23. The method according to claim 21, and comprising setting a first exposure time for the detector elements associated with the clear elements and a second exposure time, greater than the first exposure time, for the detector elements associated with the colored elements.

24. A method for image sensing, comprising:
forming a solid-state image sensor, the sensor comprising a matrix of detector elements; and
applying a mosaic filter to the image sensor, the mosaic filter comprising filter elements associated respectively with the detector elements, the filter elements comprising at least a first plurality of red elements, a second plurality of green elements and a third plurality of elements having a spectral response between red and green regions of the optical spectrum.

25. A method for image sensing comprising:
forming a solid-state image sensor, the sensor comprising a matrix of detector elements comprising respective first and second pluralities of the detector elements producing respective first and second signals and having different, respective first and second sensitivities;
determining first and second exposure times, responsively to the respective first and second sensitivities; and
exposing the first and second pluralities of the detector elements for a duration of the respective first and second exposure times.
